(19) United States
(12) Patent Application Publication
(10) Pub. No.: US 2025/0319685 A1
(43) Pub. Date: Oct. 16, 2025

(54) STRUCTURAL ELEMENT PROVIDED WITH APPLIED INSERTS FOR A COMPOSITE ACOUSTIC STRUCTURE, AND ASSOCIATED MANUFACTURING METHOD

(71) Applicant: INSTITUT DE RECHERCHE TECHNOLOGIQUE JULES VERNE, Bouguenais (FR)

(72) Inventors: Mehdi MARIN, Bouaye (FR); Stéphane BESSEMOULIN, Sainte-Luce-sur-Loire (FR); Florian RAVISE, Saint-Herblain (FR)

(73) Assignee: INSTITUT DE RECHERCHE TECHNOLOGIQUE JULES VERNE, Bouguenais (FR)

(21) Appl. No.: 18/855,818

(22) PCT Filed: Apr. 11, 2023
(86) PCT No.: PCT/EP2023/059447

§ 371 Date: Oct. 10, 2024

(30) Foreign Application Priority Data
Apr. 11, 2022 (FR) 2203325

(51) Int. Cl. B32B 3/12; B32B 3/26; B32B 7/12; B32B 38/00; B32B 38/04

(52) U.S. Cl. CPC B32B 3/12; B32B 3/266; B32B 7/12; B32B 38/0036; B32B 38/04; B32B 2038/0076; B32B 2038/042; B32B 2305/024; B32B 2305/34; B32B 2307/10

(57) ABSTRACT

The invention relates to a structural element (10) for a composite acoustic structure (100), the structural element comprising at least one cellular core (20) having a network of hollow cells (21) delimited by partitions (22) that extend between two faces (23, 24) of the cellular core (20), and at least one resistive skin (30) covering one of the faces of the cellular core (20), the structural element (10) being characterized in that it comprises a plurality of applied inserts (50), each insert (50) having a tubular through-body (51) open at the ends (53,54) thereof, and a flange (52) protruding from the associated tubular body (51), and in that the resistive skin (30) is perforated by each of the inserts (50) positioned facing all or some of the cells (21) such that, for each insert (50), the flange (52) is positioned against the resistive skin (30) on a first side, and the tubular body (51) opens out on a second side opposite the first side.

### TECHNICAL FIELD OF THE INVENTION

The invention relates, in general, to the technical field of acoustic attenuation structures or panels.

The invention relates to the manufacture of composite panels comprising a honeycomb-type cellular central core sandwiched between two skins, in particular applied to acoustic attenuation structures used to reduce noise produced in demanding environments, for example in the aeronautical field in aircraft engines such as in gas turbines or exhaust thereof, or else in the railway sector.

### PRIOR ART

Acoustic attenuation structures are typically made up on the one hand, of an acoustic plate or skin referred to as a “resistive” skin, permeable to the acoustic waves to be attenuated and, on the other hand, of a solid plate or skin referred to as a “reflective” skin, between which a core forming a cellular body is arranged, for example a honeycomb-type cellular structure.

The acoustic skin is generally acoustically porous and perforated with a multitude of holes allowing fluid communication between the outside and inside of the cellular core of the composite structure, thus forming an acoustic attenuation structure of the composite acoustic panel type.

As is well known, such acoustic attenuation structures form Helmholtz type resonators that attenuate acoustic waves in a certain frequency range, with each cell of the cellular core open at the associated perforation of the acoustic skin forming a Helmholtz resonator. These acoustic attenuation structures generally have a honeycomb type cellular core and the acoustic performance obtained is thus limited to absorbing a relatively narrow range of frequencies depending on the shape and dimensions of each of the cells.

One solution for increasing the acoustic attenuation frequency range of an acoustic structure is to stack several structural elements each comprising a cellular core, the cells having similar or different shapes and dimensions. In such a configuration, the cellular core composite attenuation structure, that is, the honeycomb structure may be a 1-degree-of-freedom structure (SDOF structure, SDOF stands for “Simple Degree Of Freedom”), a 2-degree-of-freedom structure (DDOF structure, DDOF stands for “Double Degree Of Freedom”) or, more generally, an M-degree-of-freedom structure (MDOF structure, MDOF stands for “Multiple Degree Of Freedom”), where M is an integer greater than 2.

When the composite acoustic structure has several degrees of freedom, it comprises several layers of cellular bodies or cellular cores stacked one on top of the other, with two adjacent layers of stacked cellular cores being separated by a septum. It is known that this septum consists of a microporous wall pierced with holes so that, for two given cells of a pair of stacked cells, each belonging to one and the other two separate and adjacent stacked cellular core layers, said cells of the given pair of cells communicate acoustically with each other. The septum therefore resembles an intermediate resistive skin. Although such a composite acoustic structure has a greater overall thickness, such a feature makes it possible to enlarge the volume of each Helmholtz resonator cavity and consequently extend the frequency band of attenuated acoustic waves to lower frequencies, for example between 500 and 1000 Hz.

Drilling the septum wall is well known and relatively simple to implement for planar composite acoustic structures, forming regular planar acoustic panels. However, such drilling is complex to implement for composite acoustic structures having curved or even complex shapes.

The use of applied parts designed to fit into each cell of the cellular structure to improve the acoustic performance of an acoustic panel is also known. In document FR 3 082 987, for example, truncated cones are joined together by bars at the broad bases thereof which must be positioned in notches at the ends of the cells. The truncated cones are each designed to fit inside an associated cell, each broad base being included in a section of the inner space of the associated cell.

However, this solution is difficult to implement particularly when it comes to controlling the positioning between the truncated cones and the cells as well as the sealing between these elements. Indeed, if the geometry of the notches and the bars do not match perfectly, some bars are not correctly positioned in the notches, resulting in play with the acoustic skin. The performance and watertightness of the acoustic attenuation structure are then degraded. The manufacturing method is also more difficult to implement in the case of curved parts due to the rigidity conferred on the acoustic structure by the use of truncated cones.

In addition to the complexity of the manufacturing method, the use of such an applied structure in the cells of a cellular core of an acoustic panel substantially increases the mass of the resulting acoustic panel, which is critical in certain applications such as aeronautics.

Furthermore, in the case of manufacturing a multi-degree-of-freedom structure (DDOF and MDOF), the methods for manufacturing the perforated septum are often complex to implement in the overall method for manufacturing the acoustic structure. In particular, it is known to use a method of draping a pre-impregnated fabric over a cellular body, then autoclaving it. The multiplication of insert positioning steps with this type of manufacturing method in combination with the other usual manufacturing steps of the composite acoustic structure implies a significant manufacturing time and de facto a higher manufacturing cost.

Other solutions exist consisting for example of defining the holes in an acoustically porous skin at the same time as the skin itself. This is particularly the case when using additive manufacturing methods. However, even if such a method for manufacturing the acoustically porous skin can be implemented in parallel with a method for manufacturing a complete composite structure, such methods are particularly time-consuming to implement, and present additional constraints specific to this type of manufacturing method.

### DISCLOSURE OF THE INVENTION

The invention aims to remedy some or all of the disadvantages of the state of the art by proposing, in particular, a solution that makes it possible to obtain a composite acoustic structure that is simple to and that constitutes a high-performance acoustic insulator.

To that end, according to a first aspect of the invention, a structural element for a composite acoustic structure is proposed, the structural element comprising at least one cellular core comprising a network of hollow cells delimited by partitions that extend between two faces of the cellular core, and at least one resistive skin covering one of the faces of the cellular core, the structural element being remarkable in that it comprises a plurality of applied inserts, each insert having a tubular through-body open at the ends thereof and a flange protruding from the associated tubular body, and in that the resistive skin is perforated by each of the inserts positioned facing all or some of the cells such that, for each insert, the flange is positioned against the resistive skin on a first side, and the tubular body opens out on a second side opposite the first side.

By virtue of such a combination of features, the design of the applied inserts, that is, separate from the resistive skin, is simplified and the installation thereof on a resistive skin of a structural element is straightforward, even if the associated face of the cellular core has a non-planar shape. Moreover, the use of such applied inserts does not stiffen the assembly excessively. Finally, such tubular inserts improve acoustic performance at a relatively low weight compared with prior art solutions.

In one embodiment, the inserts are formed in one piece, with the tubular body of each insert extending between a first end having the flange and a second end. Preferably, the second end is circumferentially beveled, that is, the tubular body has a reduction or a narrowing of the outside diameter thereof towards, preferably as far as, the second end. In this configuration, the end then has a frustoconical outer envelope. Such a beveled end facilitates perforation of the resistive skin.

In one embodiment, the first side of the resistive skin corresponds to the outer side of the structural element with respect to the resistive skin, opposite the cellular core, while the second side of the resistive skin is the side facing the cellular core.

In one embodiment, the resistive skin is formed from a multilayer composite structure. Preferably, the resistive skin comprises a pre-impregnated fabric, more preferably a layer of fabric interposed between two layers of adhesive. It should be noted that the features of the structural element during the manufacture thereof (in pre-impregnated form for example) are also the same once the structural element has been manufactured. The autoclave firing used to finalize manufacturing does not indeed modify the structure of the structural element or the composite acoustic structure in which it may be integrated.

In one embodiment, the tubular body of each of the inserts extends between a first and a second end along an opening axis, the tubular body having, at the first end, the flange extending in a plane orthogonal to the opening axis, the tubular body being axially open at both ends thereof.

In one embodiment, the tubular body of the inserts has a constant cross-section, for example cylindrical.

In one embodiment, the inserts are separate from one another. In this way, the inserts are not integral with each other until the resistive skin is perforated. This thus minimizes the rigidity of the resulting structural element.

In one embodiment, the applied inserts are formed in one piece, preferably from thermoplastic material(s), more preferably obtained by molding, for example by injection molding. Such inserts are simple to manufacture, resistant and inexpensive.

According to another aspect of the invention, it relates to a composite acoustic structure remarkable in that it comprises at least one structural element as described above.

In one embodiment, the acoustic structure can form a simple acoustic panel, particularly when a reflective skin is added to cover the other of the two faces of the cellular core, namely the opposite face of the resistive skin with respect to the cellular core. The result is a simple composite acoustic structure forming a panel, which may or may not be planar, with a cellular core interposed between the reflective and resistive skins.

In one embodiment, the composite acoustic structure comprises a composite structure with N degrees of freedom comprising a stacking of N cellular core layers, N being greater than or equal to 2, the composite structure comprising at least one septum separating two of the adjacent stacked cellular core layers, the resistive layer perforated by the inserts forming the septum or one of the septa of the composite acoustic structure.

If N is equal to 2, the composite structure forms a DDOF, with the resistive layer perforated by the inserts forming the septum of the DDOF. The result is a composite acoustic structure whose resistive outer skin, that is, open to the outside, can be aerodynamically shaped and which, at the same time, addresses the problems of low-frequency and high-frequency sound absorption by means of an adapted Helmholtz resonator by virtue of tubular inserts.

According to another aspect, the invention also relates to a method of manufacturing a structural element for a composite acoustic structure, the structural element comprising at least one cellular core comprising a network of hollow cells delimited by partitions that extend between two faces of the cellular core, and at least one resistive skin covering one of the faces of the cellular core, the structural element comprising a plurality of inserts, each insert having a tubular through-body open at the ends thereof and a flange protruding from the associated tubular body, the resistive skin being perforated by each of the inserts positioned facing all or some of the cells such that, for each insert, the flange is positioned against the resistive skin on a first side, and the tubular body opens out on a second side opposite the first side, the method of manufacturing the structural element being remarkable in that it comprises the following steps:
manufacturing the cellular core;
positioning the resistive skin so that it covers one of the faces of the cellular core;
positioning the inserts in the resistive skin facing some or all of the cells so that, for each positioned insert, the flange is positioned against the resistive skin on a first side, and the tubular body opens out on a second side, opposite the first side.

In one embodiment, the method of manufacturing the structural element comprises a step of coating with a preparation such as an adhesive, for example based on polymeric material(s), so as to coat the first side of the resistive skin perforated by the applied inserts and the upper faces of the flanges of the inserts, the coating step preferably being followed by a cross-linking step, more preferably by the addition of heat.

The resistive skin with the inserted inserts is thus covered with a film of a predetermined preparation such as a film of adhesive, for example an epoxy adhesive which will be cross-linked with the addition of heat, particularly around the orifices delimited by the tubular body of the inserts in order to free the orifices from the adhesive. This additional layer of adhesive allows the flanges of the inserts to be embedded between two layers, the associated resistive skin on the one hand, and the preparation to be cross-linked on the other, to guarantee improved holding of the inserts during the operating life of the acoustic structure. In the case of a DDOF, the adhesive has the added advantage of fulfilling a dual function, on the one hand, it holds the inserts in place against the associated skin, and on the other hand, it bonds the two cellular core layers of the DDOF structure when the skin perforated by the inserts forms the septum separating them.

In one embodiment, the step of positioning the inserts in the resistive skin comprises at least:
a first positioning step wherein a tool carries at least one punch and faces a cell, the punch having a head configured to come into contact with the flange of the associated insert, and a rod, the rod passing axially through the tubular body of the associated insert along the opening axis thereof;
a second positioning step, subsequent to the first positioning step, wherein the punch is moved by axial translation along the opening axis so as to perforate the resistive skin, the head of the punch pushing the insert until the flange thereof comes into direct contact with the resistive skin; and
a third positioning step wherein the punch withdraws leaving the insert in the resistive skin.

In another aspect of the invention, the latter also relates to a method of manufacturing a composite acoustic structure as described above, the method of manufacturing the composite acoustic structure being characterized in that it comprises the following steps:
manufacturing a structural element according to the method described above;
assembling the structural element with at least one skin, preferably a resistive or reflective skin, covering the other of the two faces of the cellular core.

This separate skin to which the structural element is assembled is in particular a reflective skin, for example in the case of an SDOF structure or may be for example another reflective skin, for example if the reflective skin of the structural element is intended to form the septum of a DDOS structure.

According to one embodiment, the method of manufacturing the composite acoustic structure comprises a step of stacking at least one cellular core layer with the composite acoustic structure.

Preferably, the reflective skin is draped in pre-impregnated form, with an autoclave firing step more preferably being carried out after assembly.

### BRIEF DESCRIPTION OF THE FIGURES

Other features and advantages of the invention will become apparent on reading the following description, with reference to the appended figures, which show:

FIG. 1: a schematic cross-sectional view of part of a complex-shaped composite acoustic structure according to a first embodiment;

FIG. 2: a schematic cross-sectional view of part of a planar composite acoustic structure in another embodiment, shown without the resistive and reflective skins on the end faces;

FIG. 3: an isometric perspective view from below of the composite acoustic structure shown in FIG. 2;

FIG. 4: a top view of the composite acoustic structure of FIG. 2;

FIG. 5A: a view of a first step of positioning an insert in the resistive skin of a method for manufacturing a structural element according to one embodiment;

FIG. 5B: a view of a second step of positioning the insert in the resistive skin of the method for manufacturing a structural element, this second step being subsequent to the first step of FIG. 5A;

FIG. 5C: a view of a third step of positioning the insert in the resistive skin of the method for manufacturing a structural element, this third step being subsequent to the second step of FIG. 5B;

FIG. 6A: a schematic cross-sectional view taken locally at an insert of a preparation coating step, so as to coat the outside of a resistive skin perforated by the inserts and the upper faces of the flanges of the inserts;

FIG. 6B: a view similar to FIG. 6A wherein the preparation coating step has been followed by a cross-linking step.

For greater clarity, identical or similar elements are identified by identical reference signs in all of the Figures.

### DETAILED DESCRIPTION OF AN EMBODIMENT

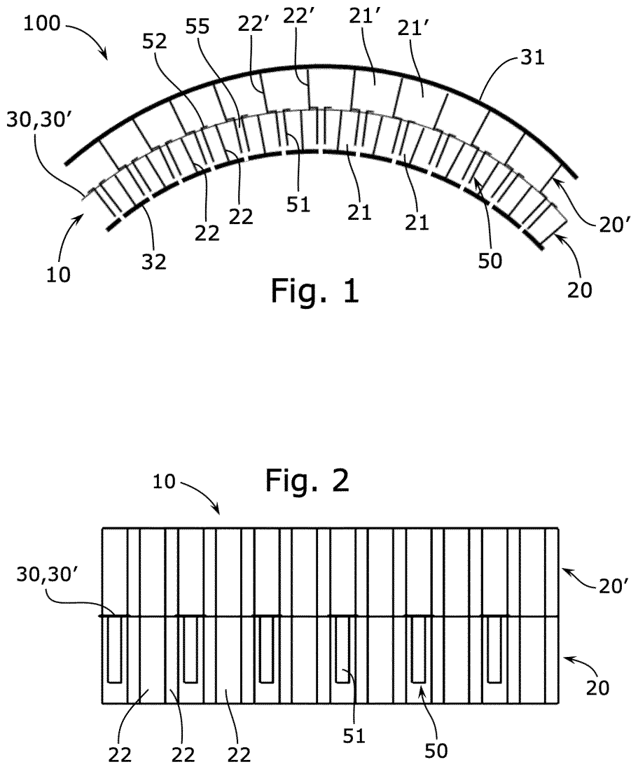

FIG. 1 shows a schematic cross-sectional view of part of a composite acoustic structure 100 according to one embodiment of the invention.

The acoustic attenuation structure 100 herein comprises a structure with two degrees of freedom, commonly referred to as a “DDOF”. The acoustic attenuation structure 100 comprises a stacking of two cellular cores 20, 20′, a lower cellular core 20 and an upper cellular core 20′, each comprising a network of hollow cells 21, 21′ delimited by partitions 22, 22′. The two cellular cores 20, 20′ are separated from each other by a septum 30′. Each of these cellular cores 20, 20′ herein consist of a honeycomb-type structure, for example NIDAR. For example, the cells 21, 21′ in the different layers of cells 20, 20′ are selected to have different thicknesses according to the layers in order to attenuate acoustic waves of different frequency bands. The honeycomb structure of each of the cellular cores 20, 20′ preferably consists of at least one metal material, more preferably of metal material(s) capable of withstanding high temperatures depending on the desired uses. In the field of aeronautics, for example, metal material(s) can be selected to withstand hot ejection temperatures. The materials used to form the network of cells 21, 21′ may of course be different, for example thermoplastic material(s) or synthetic material(s), for example aramid. It should also be noted that other shapes of cells 21, 21′ may be used, and not only hexagonal honeycomb shapes.

The cellular structure formed by the stacking of the two cellular cores 20, 20′ is covered:
on a first of the two faces thereof, with a resistive skin 31, also known as an acoustic skin, permeable to the acoustic waves to be attenuated and covered, and
on another of the two faces thereof, opposite the face covered by the resistive skin 31, with a reflective skin 32, also known as a solid skin, which is generally oriented away from a noise source, i.e. to the rear with respect to the composite acoustic structure.

The septum 30′ in turn forms an intermediate resistive skin separating the two cellular cores 20, 20′.

The interior space of the cells is particularly important in that each of the cells of this central cellular structure, namely each of the cells of the two cellular cores 20, 20′, forms a Helmholtz resonator. The resonator thus consists of a bottle, formed by a honeycomb cell and a neck formed by a hole in the resistive skin. In order to optimize acoustic performance, the septum 30′ is itself also perforated so that the entire thickness of the DDOF structure is thus used to attenuate acoustic waves, the cells of the two cellular cores 20, 20′ being stacked, with a given pair of stacked cells 21, 21′ communicating with each other via an orifice 55 in the septum 30′. In this way, the septum 30′ forms an intermediate resistive skin, between the two cellular cores 20, 20′.

These orifices 55 are each delimited by an insert 50. Each insert 50 has a tubular through-body 51 open at the ends 53, 54 thereof and a flange 52 protruding from the associated tubular body 51. As the tubular body 51 is through-going, it allows acoustic waves to communicate therethrough between two cells 21, 21′ of a given pair of stacked cells of the cellular cores 20, 20′.

The intermediate resistive skin 30 formed herein by the septum 30′ is perforated by each of the applied inserts 50, which are positioned opposite all or some of the cells 21 of the lower cellular core 20. The lower cellular core 20 and the septum 30′ together form a structural element 10. Alternatively, it may also be possible to manufacture a structural element 10 comprising the septum 30′ forming the resistive skin and the upper cellular core 20′, but this is more complex to manufacture as it implies that for each positioned insert, the flange is positioned against the resistive skin on a first side, and the tubular body opens out on a second side, opposite the first side, the first side of the resistive skin corresponding to the inner side, facing the cellular core, the second side of the resistive skin being the outer side of the structural element with respect to the resistive skin, opposite the cellular core.

It should also be noted that the structural element 10 may be integrated into a structure other than a DDOF. For example, the composite acoustic structure could be a simple composite panel formed by the cellular core 20 sandwiched between the reflective 31 and resistive skins 30, 32. According to another example, the composite acoustic structure could comprise more than 2 degrees of freedom, for example 3. In this case, the resistive skin pierced by the applied inserts 50 may be one of the intermediate skins forming the septum, or even the outer resistive skin. Preferably, a configuration is selected in which the resistive skin pierced by the inserts 50 forms a septum separating two of the cellular core layers, for example to ensure the flatness of the outer resistive layer in order to ensure optimum aerodynamic performance.

In this embodiment, the structural element 10 thus formed is configured so that, for each insert 50:
the flange 52 of said inserts 50 is positioned against the associated resistive skin 30, herein the septum 30′, on a first side herein outside the structural element 10 with respect to the associated resistive skin 30, namely herein on the side opposite the lower cellular core 20, and
the tubular body 51 opens out on a second side, opposite the first side, in particular into one of the associated cells 21 of the lower cellular core 20.

The applied inserts 50 are independent of each other, that is, they are not connected to each other, other than of course by the septum 30′ once positioned thereon. In other words, they are not connected by dedicated fastening means, unlike the prior art.

The tubular body 51 of the inserts 50 is cylindrical and axially open at both ends 53, 54 thereof. This thus allows acoustic waves to communicate through the hollow space opened therethrough by the tubular body 51 delimiting the associated orifice 55.

The tubular body 51 of each insert 50 extends between the two ends thereof, namely a first and a second end 53, 54 along an opening axis A. Once an insert 50 has been positioned on the resistive skin herein forming the septum 30′, the opening axis A is such that it is oriented at least locally perpendicular to the face of the cellular core 20 covered by the septum 30′.

The tubular body 51 carries at the first end 53, the flange 52 which extends in a plane P orthogonal to the opening axis A. The flange 52 has the shape of a disc crown coaxially surrounding the tubular portion of the first end 53 of the tubular body 51. The inserts 50 are pressed through the resistive skin herein forming the septum 30′ so that the flange 52 comes into direct contact with said associated skin.

To simplify manufacture, the inserts 50 are each formed in one piece, preferably from thermoplastic materials, more preferably obtained by molding, for example by injection molding. Examples of thermoplastic materials that can be used include polyetheretherketone (PEEK), polyetherimide (PEI), polyphenylene sulfide (PPS), or even polycarbonate (PC). Of course, other materials may be used alone or in combination. Similarly, other manufacturing methods may also be used such as extrusion or additive manufacturing.

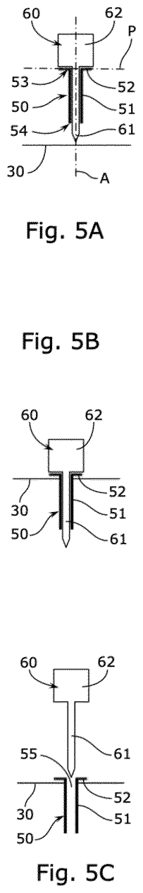

Each insert 50 may have a second end 54 circumferentially beveled in the direction of a diameter narrowing of the tubular body towards the second end 54. This bevel may facilitate the positioning of the associated insert 50 when perforating the skin, even if the second end 54 is not designed to perforate said skin itself, for example when using a punch 60 (see FIGS. 5A, 5B and 5C described below). This bevel may also be obtained to facilitate the manufacture of the insert 50 by forming a draft.

The internal diameter of the tubular body 51 is predetermined and calibrated according to the intended use of the composite acoustic structure 100, the dimensions thereof and the frequency ranges of the acoustic waves to be attenuated.

The flange 52 and the tubular body 51 are connected by a fillet positioned on the side of the second end 54. If the insert is manufactured by being molded, the fillet offers the advantage of allowing a more homogeneous cooling rate, if the insert 50 is made of metal material(s) in particular, or of ensuring a good flow into the mold and therefore good filling, if the insert 50 is made of thermoplastic material(s) in particular, or more simply of guaranteeing good removal from the mold of the part. Once inserted through the resistive skin 30, formed herein by the septum 30′, the fillet comes into contact with the perforated skin into which the insert 50 is inserted and softens the angle to preserve the skin edge intact at the perforation.

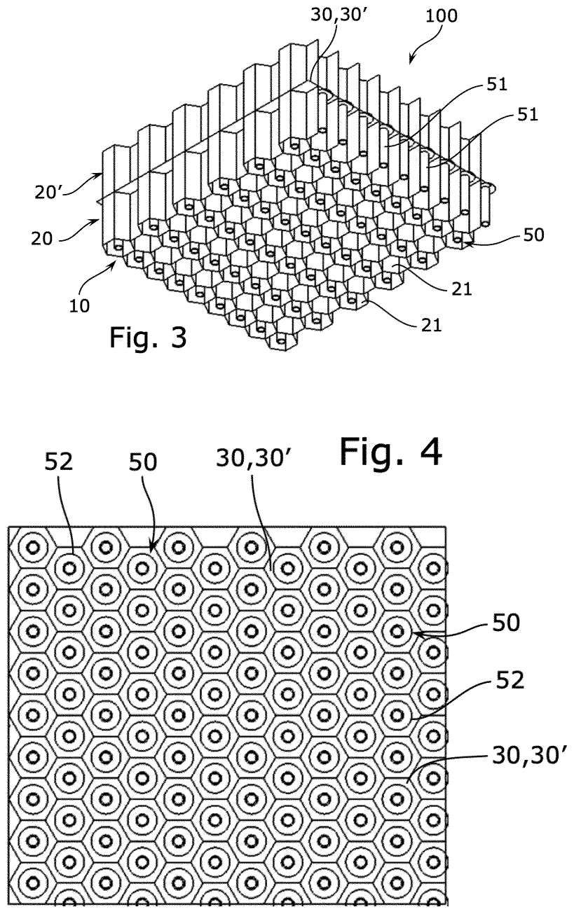

FIGS. 2, 3 and 4 show schematic views of part of a composite acoustic structure 100 shown without the resistive 32 and reflective skins 31 at the end faces, in cross-sectional, isometric bottom, and top perspective views respectively.

This second embodiment shown in FIGS. 2, 3 and 4 differs from the first embodiment shown in FIG. 1 essentially in that it is planar, that is, it does not have a complex curved shape.

The manufacture of this type of panel will be better understood in light of the following description.

A first step in the manufacturing method consists in manufacturing the structural element 10. Initially, the cellular core 20 is manufactured to form the lower cellular core 20 of the final DDOS, the cellular core 20 herein having the form of a honeycomb structure.

If the cellular core has a complex shape, for example a non-planar curved shape, as shown in FIG. 1 for example, the cellular core 20 can then be formed at this stage of the method.

Next, the resistive skin 30 of the structural element 10 is positioned so as to cover one of the faces 23, 24 of the cellular core 20. The resistive skin is formed from a multi-layer composite structure. It is draped over the associated face of the cellular core 20 in the form of a multi-layer pre-impregnated film. This multi-layer pre-impregnated skin notably comprises at least one structural ply, for example a glass-fiber fabric pre-impregnated with epoxy resin. This structural plus is also interposed between two films of epoxy adhesive, one layer of which will be in contact with one end of the partitions 22 of the network of cells 21 of the lower cellular core 20 on the side of the skin-covered face.

Of course, the nature of each layer constituting the resistive skin 30 of the structural element 10 may be different. For example, layers may be woven or non-woven. Several structural plies may be stacked, which is particularly advantageous in terms of strength. Strength is further enhanced when the fibers in the various woven plies have different orientations. The orientation of the fibers is configured so as to ensure the best strength for the desired end use. The layers of adhesive(s) may also vary and may or may not be woven. The fabric of the woven ply (plies) may also be made of a material other than glass, for example carbon fiber. One of the layers may also be a thermoplastic film or fabric.

To ensure perfect sealing of the associated resistive skin, which is particularly important for guaranteeing good sound absorption, a multi-layer skin with an impermeable air barrier is preferably selected, with at least one of the layers being impermeable to air and having an airflow resistance greater than or equal to approximately 50 MKS rayls, i.e. 50 kg s⁻¹·m⁻² in fundamental SI units.

Once the pre-impregnated resistive skin 30 has been positioned covering one of the faces 23, 24 of the cellular core 20, all the inserts 50 are positioned in the resistive skin 30 opposite all or some of the cells 21 of the cellular core 20 so that, in this example and for each positioned insert 50, the flange 52 is located directly against the resistive skin 30 on the outer side of the structural element 10 with respect to the resistive skin 30, opposite the cellular core 20, and the tubular body 51 opens into the associated cell 21.

This method of positioning inserts 50 is shown in detail in FIGS. 5A, 5B and 5C. In particular, the following are shown respectively:
a first step of positioning an insert 50 in the resistive skin 30 of the structural element 10 wherein a tool (not shown) carries a punch 60 and faces a cell 21, the punch 60 having a head 62 configured to come into contact with the flange 52 of the insert 50, and a rod 61, the rod 61 passing axially through the tubular body 51 of the insert 50 along the opening axis A thereof. The rod 61 extends axially under the head 62 and is longer than the insert 50 which ensures that the rod 61 passes through the tubular body 51 of the insert 50 on both sides. The external diameter of the rod 61 is selected so as to be substantially equal to the internal diameter of the tubular body 51 so that the friction generated between the punch 60 and the insert 50 is sufficient to keep the insert 50 pressed onto the punch during this first step, without however over-stressing it so that it remains possible to remove the insert 50;
a second step of positioning the insert 50 in the resistive skin 30 of the method for manufacturing the structural element 10, this second step being subsequent to the first step. Herein, the punch 60 is moved by axial translation, along the opening axis A. As the rod 61 passes axially through the tubular body 51 of the insert 50 along the opening axis A thereof, the distal end of the rod 61 comes into contact first, i.e. before the insert 50, with the resistive skin 30 during the movement of the insert 50 by the punch 60. The distal end of the rod 61 is fitted with a point to facilitate perforation of the resistive skin 30. The punch 60 is moved along the opening axis A so as to perforate the skin 30, the head 62 of the punch pushing the insert 50 until the flange 52 thereof comes into direct contact with the prepreg 30. During this step, the flange 52 is bonded to the first layer of the pre-impregnated reflective skin. The choice of a pre-impregnated top layer of skin 30 should thus guarantee bonding of the insert 50 and thus, when the punch 60 moves in the opposite direction in order to withdraw, the insert 50 remains in position while the punch 60 withdraws;
a third step of positioning the insert 50 in the resistive skin 30 wherein the punch 60 withdraws leaving the insert 50 in the skin 30 by virtue of the tackiness of the resistive skin 30 which is greater than the friction forces holding the insert 50 on the punch 60;
then the punch 60 searches for another insert 50 and repeats the steps for positioning the insert 50, until all the inserts 60 have been positioned on the structural element 10.

Note that the tool may be for example a robotic arm provided with the punch 60 at the end thereof. Alternatively, the robotic arm may be configured to place one insert 50 at a time, and comprise a single punch 60, or else carry several punches 60 and thus be configured to position several inserts 50 synchronously. The advantage of a positioning tool carried by a robotic arm is that it makes it easier to position the inserts 50 along a complex surface. The robotic arm is for example a 6-axis robotic arm.

According to one feature, care is taken to ensure that the length of the insert 50, that is, the tubular body 51 thereof, is strictly less than the depth of the associated cell 21. This ensures that each insert 50 has clearance between a bottom of the associated cell and the second distal end 54 of the insert 50. In this way, the insert 50 does not interfere with the skin that will be positioned on the other face of the cellular core 20 prior to its draping. Similarly, once the structural element has been formed, after firing, such a feature guarantees good sound absorption.

Once all the inserts 50 have been positioned, a step for coating with a preparation 40 is carried out. The preparation may be for example an adhesive, for example based on polymeric materials. This step notably involves coating at least on the one hand the outer side of the resistive skin 30 perforated by the inserts 50, the side against which the lower faces of the flanges 52 of the inserts 50 are in contact, and on the other hand the upper faces of the flanges 52 of the inserts 50. The coating step is followed by a cross-linking step, for example by the addition of heat.

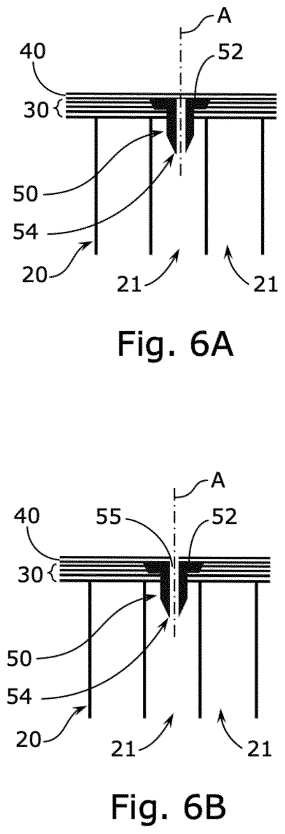

In other words, the multi-layer resistive skin 30 provided with the inserts 50 then inserted through said skin is thus covered with a film of epoxy adhesive which is then cross-linked with the addition of heat around the orifices 55 of the inserts 50 in order to free them of adhesive (see FIGS. 6A and 6B). The cross-linking of the adhesive hardens the adhesive, and any adhesive placed in the orifices 55 of the tubular bodies 51 withdraws locally leaving these orifices 55 free. This additional layer 40 allows the flanges 52 of the inserts 50 to be embedded between the additional preparation layer on the one hand, and the resistive skin 30 on the other hand, to ensure that the inserts 50 are held in place during the operating life of the composite acoustic structure 100. A flange 52 is selected for each insert 50 with a minimum thickness to ensure the flatness of the skin once the inserts have been applied and inserted into the multi-layer skin 30 and embedded with the cross-linked preparation layer.

Once the structural element 10 has been formed, it is assembled with at least one skin, such as a resistive skin 32 (see for example FIG. 1) so that it covers the other of the two faces of the cellular core 20. In the case of a DDOF, another cellular core 20′ and the reflective skin 31 thereof are also glued together.

Once the composite structure has been assembled, the assembly is placed in an autoclave to undergo a firing step. In this way, the different septa 30′ separating the different layers of cellular core 20, 20′, the different layers of cellular core 20, 20′, the rear reflective skin 32 and the front outer resistive skin 31 are assembled as a single piece before being introduced into the autoclave.

The result is thus a composite acoustic structure that extends to the desired shape and offers optimum technical characteristics.

Of course, the invention is described in the foregoing by way of example. It is understood that a person skilled in the art is able to produce different variant embodiments of the invention without departing from the scope of the invention.

For example, the structural element may be autoclaved alone then the structural element may be integrated into a composite acoustic structure using another method, for example by brazing.

It is emphasized that all of the features, as they are taught to a person skilled in the art from the present disclosure, drawings and attached claims, even though specifically they have been described in relation to other determined features, both individually and in any combinations, may be combined with other features or feature groups disclosed herein, provided that this has not been expressly excluded and that no technical circumstances make such combinations impossible or nonsensical.

1. A structural element for a composite acoustic structure, the structural element comprising:
at least one cellular core having a network of hollow cells delimited by partitions that extend between two faces of the cellular core; and
a resistive skin covering one of the faces of the cellular core,
wherein the structural element comprises a plurality of applied inserts, each insert having a tubular through-body open ends thereof, and a flange protruding from the tubular through-body, the resistive skin being perforated by each of the inserts positioned facing all or some of the cells such that, for each insert, the flange is positioned against the resistive skin on a first side, and the tubular body opens out on a second side opposite the first side,
wherein the inserts are formed in one piece, the tubular body of each of the inserts extending between a first end having the flange and a second end, said second end being circumferentially beveled.

2. The structural element according to claim 1, wherein the resistive skin is formed from a multilayer composite structure.

3. The structural element according to claim 1, wherein the tubular body of each of the inserts extends between a first end and a second end along an opening axis, the tubular body having, at the first end, the flange extending in a plane orthogonal to the opening axis, the tubular body being axially open at both ends thereof.

4. The structural element according to claim 2, wherein the tubular body of the inserts has a constant cross-section.

5. The structural element according to claim 1, wherein the inserts are separate from one another.

6. The structural element according to claim 1, wherein the applied inserts are formed from thermoplastic material(s).

7. A composite acoustic structure, wherein the composite acoustic structure comprises at least one structural element according to claim 1.

8. The composite acoustic structure according to claim 7, wherein the composite acoustic structure comprises N degrees of freedom formed by a stacking of N layers of cellular core to form stacked layers, N being greater than or equal to 2, the composite acoustic structure comprising at least one septum separating two of the stacked layers each other of the cellular core, a resistive layer perforated by the inserts forming the septum or one septa of the septum of the composite acoustic structure.

9. A method of manufacturing a structural element for a composite acoustic structure, the structural element comprising:
at least one cellular core comprising a network of hollow cells delimited by partitions that extend between two faces of the cellular core; and
a resistive skin covering one of the faces of the cellular core, the structural element comprising a plurality of applied inserts, each insert having a tubular through-body open at ends thereof and a flange protruding from the tubular body, the resistive skin being perforated by each of the inserts positioned facing all or some of the cells such that, for each insert, the flange is positioned against the resistive skin on a first side, and the tubular body opens out on a second side opposite the first side, wherein the method of manufacturing the structural element comprises the following steps:
manufacturing the cellular core;
positioning the resistive skin so that it covers one of the faces of the cellular core;
positioning the inserts in the resistive skin facing all or some of the cells of the cellular core such that, for each positioned insert, the flange is positioned against the resistive skin on a first side, and the tubular body opens out on a second side, opposite the first side.

10. The manufacturing method according to claim 9, wherein the method further comprises a step of coating with a preparation such as an adhesive so as to coat the first side of the resistive skin perforated by the applied inserts and upper faces of the flanges of the inserts.

11. The manufacturing method according to claim 9, wherein the step of positioning the inserts in the resistive skin comprises at least:
a first positioning step wherein a tool carries at least one punch and faces a cell, the punch having a head configured to come into contact with the flange of the insert, and a rod, the rod passing axially through the tubular body of the insert along an opening axis thereof;
a second positioning step, subsequent to the first positioning step, wherein the punch is moved by axial translation along the opening axis so as to perforate the resistive skin, the head of the punch pushing the insert until the flange thereof comes into direct contact with the resistive skin; and
a third positioning step wherein the punch is withdrawn, leaving the insert in the resistive skin.

12. A method of manufacturing a composite acoustic structure comprising N degrees of freedom formed by a stacking of N layers of cellular core to form stacked layers, N being greater than or equal to 2, the composite acoustic structure comprising at least one septum separating two of the stacked layers adjacent each other of the cellular core, a resistive layer perforated by the inserts forming the septum or one septa of the septum of the composite acoustic structure, wherein the method of manufacturing the composite acoustic structure comprises the following steps:
manufacturing a structural element according to claim 9;
assembling the structural element with at least one skin, preferably a resistive or reflective skin, covering the other of the two faces of the cellular core.

13. The manufacturing method according to claim 12, wherein the method comprises a step of stacking at least one layer of cellular core with the composite acoustic structure.

14. The manufacturing method according to claim 10, wherein the step of coating is followed by a cross linking step.

15. The manufacturing method according to claim 10, wherein the step of coating is followed by a heating step.
